(19) United States
(12) Patent Application Publication
(10) Pub. No.: US 2005/0127833 A1
(43) Pub. Date: Jun. 16, 2005

(54) White light LED and method to adjust the color output of same

(76) Inventor: Dwayne A. Tieszen, Ponder, TX (US)

Correspondence Address: LITMAN LAW OFFICES, LTD, PO BOX 15035, CRYSTAL CITY STATION, ARLINGTON, VA, 22215, US

(21) Appl. No.: 10/730,918

(22) Filed: Dec. 10, 2003

(51) Int. Cl. H05B 33/04

(52) U.S. Cl. 313/512; 313/485; 313/486

(57) ABSTRACT

A white light LED having high color rendering indices and a correlated color temperature similar to that of an incandescent lamp. The LED has a semiconductor body formed of a semiconductor layer sequence capable of emitting electromagnetic radiation in a blue spectral range, the radiation exciting a yellow phosphor resulting in an intermediate blue-yellow light output whose chromaticity coordinates are transformed by a casting compound encompassing the semiconductor body and phosphor. A colored tint blended with epoxy resin forms the casting compound and filters the blue-yellow output, passing the red wavelength components of the blue-yellow output while attenuating the blue-yellow spectral wavelength, resulting in a balanced white output having a correlated color temperature, chromaticity coordinates, and color rendering indices similar to that of-an incandescent lamp output.

### BACKGROUND OF THE INVENTION

1. Field of the Invention

The present invention relates to light emitting diodes (LEDs), and specifically to LEDs having a white light output.

2. Description of the Related Art

Visible light is a collection of electromagnetic waves (electromagnetic radiation) of different frequencies, each wavelength representing a particular “color” of the light spectrum. Visible light includes those light waves with a wavelength between about 400 nm and about 700 nm. Each of the wavelengths within this spectrum comprises a distinct color of light from deep blue/purple at around 400 nm to dark red at around 700 nm. Mixing these colors of light produces additional colors of light. These wavelengths combine additively to produce the resulting wave or spectrum that makes up a color. One such color is white light.

Because of the importance of white light, and since white light is the mixing of multiple wavelengths of light, there have arisen multiple techniques for characterization of white light that relate to how human beings interpret a particular white light. The first of these is the use of color temperature, which provides an index to the “whiteness” of the white light.

Correlated color temperature (CCT) is characterized in color reproduction fields according to the temperature in degrees Kelvin (K) of a black body radiator that radiates the same color light as the light in question. A cooler white light, similar to the light generated by commercial fluorescent lamps, has a higher CCT, whereas a warmer white light, similar to the light generated by residential incandescent lamps, has a lower CCT. Direct sunlight has a color temperature of about 4,874 K, while indirect sunlight has a white color temperature of about 6,774 K, and an incandescent bulb has a white color temperature of about 2854 K. A color image viewed at 3,000 K will have a relatively reddish tone, whereas the same color image viewed at 10,000 K will have a relatively bluish tone. All of this light is called “white”, but it has varying spectral content.

A second term applied to identify the color of the light source regardless of its lighting level or lumen is the chromaticity of the light source. When the chromaticity of different light sources is equal, the color of the light from each light source appears the same to the eye regardless of the lighting level. Chromaticity is measured in coordinates based upon a standard developed by the Commission Internationale de l'Eclairage (CIE) in 1931. An example of such coordinates is shown in Table 1, which identifies the X, Y chromaticity coordinates for the listed white light sources. FIG. 2 graphically illustrates the color and wavelength of the emitted light represented by X,Y coordinates based upon the CIE 1931 Standard, and highlights the rather large coordinate space covered by what is generally called “white” light.

TABLE 1
White Points Defined in CIE 1931 Standard

| | | | Color | |
|---|---|---|---|---|
| Name | X | Y | Temperature | Comments |
| A | 0.4476 | 0.4075 | 2854° K | Incandescent Light |
| B | 0.3840 | 0.3516 | 4874° K | Direct Sunlight |
| C | 0.3101 | 0.3162 | 6774° K | Indirect Sunlight |
| D5000 | 0.3457 | 0.3586 | 5000° K | Bright Incandescent |
| | | | | Light |
| D6500 | 0.3127 | 0.3297 | 6504° K | “Natural” Daylight |
| E | 0.3333 | 0.3333 | 5500° K | Normalized Reference |

Another classification of white light involves its quality. In 1965 the CIE recommended a method for measuring the color rendering properties of light sources based on a test color sample method. In essence, this method involves the spectroradiometric measurement of the light source under test. This data is multiplied by the reflectance spectrums of eight color samples. The resulting spectrums are converted to tristimulus values based on the CIE 1931 standard observer. The shift of these values with respect to a reference light are determined for the uniform color space (UCS) recommended in 1960 by the CIE. The average of the eight color shifts is calculated to generate the general color rendering index, known as CRI. Within these calculations the CRI is scaled so that a perfect score equals 100, where perfect would be using a source spectrally equal to the reference source (often sunlight or full spectrum white light) . For example a tungsten-halogen source compared to full spectrum white light might have a CRI of 99 while a warm white fluorescent lamp would have a CRI of 50.

In the early 1990's a revolution in LED technology occurred when a new type of discrete LED was developed that produced “white” light. Prior to that time, no single LED was available that produced a white color output. A white color from an LED was achieved only by combining into a single package, three LEDs each of which emitted a primary color—red, green, and blue. By electrically varying the intensity of each of the imbedded colored LEDs, an infinite variety of mixed color LEDs could be obtained. This technology is still a viable option in many applications. However, the use is expensive in terms of the LEDs themselves, as well as the electronics to adequately control the subtle mix of light intensities.

The current commonly used method of producing “white” light from a single LED is to use a blue LED base chip to radiate blue light through a blended phosphor coating that emits a yellow light. In correct ratios, this blue-yellow light combination emits a perceived “white” light. However, this technique has the drawback of emitting a “white” light that has little or no red wavelength component when compared to the dominant blue wavelength. The resulting “white” light casts a very sterile, harsh, and unnaturally “cold” light.

Another problem arises in the manufacturing process of white LEDs. Due to the extreme sensitivity of the chemicals and ratios used in the manufacture of a suitable blue LED base chip and its phosphor coating, the smallest variance in these elements or the conditions under which they are applied, results in wildly varying shades of blue-white. This problem is so prevalent that production runs of white LEDs must be sorted into multiple categories in order to provide the user with devices having relatively consistent optical outputs. A typical manufacturer's specification sheet for white light LEDs is shown in Table 2, and lists four color ranks and their associated X,Y chromaticity coordinates. However, even within a category, the tolerances are broadly applied because no two white light LEDs produced emit consistent output.

TABLE 2
Color Ranks (I_{F} = 20 mA, Ta = 25° C.)

| | Rank a0 | | | | | Rank b1 | | | |
|---|---|---|---|---|---|---|---|---|---|
| X | 0.280 | 0.264 | 0.283 | 0.296 | X | 0.287 | 0.283 | 0.330 | 0.330 |
| Y | 0.248 | 0.267 | 0.305 | 0.276 | Y | 0.295 | 0.305 | 0.360 | 0.339 |
| | Rank b2 | | | | | Rank c0 | | | |
| X | 0.296 | 0.287 | 0.330 | 0.330 | X | 0.330 | 0.330 | 0.361 | 0.356 |
| Y | 0.276 | 0.295 | 0.339 | 0.318 | Y | 0.318 | 0.360 | 0.385 | 0.351 |

In summary, there has been much research and development in an attempt to modify the “cold” output of these white LEDs into a softer, warmer, more pleasing, and natural white light.

U.S. patent Publication No. 2002/0097000, published July 2002, discloses an LED luminary system for providing power to LED light sources to generate a desired light color. The system comprises a power supply stage configured to provide a DC current signal. A light mixing circuit is coupled to the power supply stage and includes a plurality of LED light sources with red, green and blue colors to produce various desired lights with desired color temperatures. A controller system is coupled to the power supply stage and is configured to provide control signals to the power supply stage in order to maintain the DC current signal at a desired level for maintaining the desired light output. The controller system is further configured to estimate lumen output fractions associated with the LED light sources based on junction temperature of the LED light sources and chromaticity coordinates of the desired light to be generated at the light mixing circuit. The light mixing circuit further comprises a temperature sensor for measuring the temperature associated with the LED light sources and a light detector for measuring lumen output level of light generated by the LED light sources. Based on the temperatures measured, the controller system determines the amount of output lumen that each of the LED light sources needs to generate in order to achieve the desired mixed light output, and the light detector in conjunction with a feedback loop maintains the required lumen output for each of the LED light sources.

U.S. patent Publication No. 2003/0070681, published June 2002, discloses an LED lamp including blue and red LEDs and a phosphor. The blue LED produces an emission at a wavelength falling within a blue wavelength range. The red LED produces an emission at a wavelength falling within a red wavelength range. The phosphor is photoexcited by the emission of the blue LED to exhibit a luminescence having an emission spectrum in an intermediate wavelength range between the blue and red wavelength ranges.

U.S. Pat. No. 6,337,536, issued to Matsubara et al. in Jan. 2002, relates to a white color light emitting diode (LED) that produces white light from a single LED chip, and further relates to a neutral color LED. The epitaxial layer emits blue or bluegreen light, and the doped substrate converts blue or bluegreen light to yellow or orange SA-emission. The blue or bluegreen light from the epitaxial film structure and the yellow or orange light from the substrate synthesize white color light or a neutral color light between red and blue.

U.S. patent Publication No. 2002/0158585, published October 2002, discloses phosphor blends that convert electromagnetic radiation emitted by near-UV/blue high-emitting devices to white light in the range of wavelengths from about 490 nm to about 770 nm. U.S. Pat. No. 5,851,063, issued to Doughty et al. in December 1998, discloses a system of at least three multi-colored LED's that has a color rendering index optimized by proper selection of the wavelengths of each LED.

U.S. Pat. No. 6,613,247, issued to Hoen et al. in Sep. 2002, discloses a wavelength-converting casting composition that is based on a transparent, epoxy casting resin with a luminous substance admixed. The composition is used in an electroluminescent component having a body that emits ultraviolet, blue or green light. An inorganic powder with luminous substance pigments is dispersed in the transparent epoxy casting resin. The luminous substance is a powder of garnets, thiogallates, aluminates, or orthosilicates doped with rare earths, and preferably Ce-doped (cesium doped) phosphors.

U.S. patent Publication No. 2003/0052599, published Mar. 2003, discloses a white light LED illumination apparatus that comprises a printed circuit board, a plurality of single color LEDs mounted on the printed circuit board, at least one electrical terminal and a transparent casing with a fluorescent material layer, connected to at least one electrical terminal. The layer of fluorescent material can be activated by the light generated from the plurality of single color LEDs to generate light by mixing with the light from the single color LEDs to generate white light

U.S. patent Publication No. 2003/0076056, published April 2003, discloses a method and apparatus for controlling an RBG based LED luminary which measures the output signals of filtered photodiodes and unfiltered photodiodes and correlates these values to chromaticity coordinates for each of the red, green and blue LEDs of the luminary. Forward currents driving the LED luminary are adjusted in accordance with differences between the chromaticity coordinates of each of the red, green and blue LEDs and the chromaticity coordinates of a desired mixed color light.

In U.S. patent application No. 2003/0147242, published Aug. 2003, an LED array is disclosed that provides white light having a warm hue by combining yellow LEDs and white LEDs in the array. The yellow LEDs are typically less expensive than the white LEDs, thereby improving the cost-efficiency of the LED array.

The devices disclosed above fall into two distinct categories. The first category relates to devices that use die-level, mixed die combinations, or external control of red, green, and blue emission components in an attempt to produce acceptable white light from the components. The other category uses die-level, mixed die phosphors to produce acceptable white light from the irradiated phosphors. To date, all of these devices and methods have been unsuccessful in producing a white LED with the pleasing characteristics of an incandescent lamp.

None of the above inventions and patents, taken either singly or in combination, is seen to describe the instant invention as claimed. Thus a white light LED and a method to adjust the color output of the LED solving the aforementioned problems is desired.

### SUMMARY OF THE INVENTION

The present invention is a white light LED having a CRI higher then most white light LEDs and a CCT similar to that of an incandescent lamp.

When a color LED is manufactured, the appropriate chemicals are doped to a desired design of LED die frame. The assembly is cured, then encapsulated into an epoxy housing of the desired shape for its specific application and optical characteristics. According to the present invention, by introducing into the encapsulating epoxy material of a white LED an optically clear tint of the proper color and ratio to complement the doped phosphor, the resultant light output of the LED can be uniformly and consistently shifted to a range of desired chromaticity coordinates. The tint must be non-reactive to the encapsulating material and die chemicals and not be affected by processing heat or subsequent manufacturing processes. Furthermore, the tint must be chemically stabilized to retain its properties when exposed to the light output of the LED itself, as well as any ultraviolet radiation present in the application environment.

The LED of the present invention has a semiconductor body formed of a semiconductor layer sequence capable of emitting electromagnetic radiation in the blue spectral range. The radiation excites a phosphor blend comprising a yellow phosphor, resulting in an intermediate light output whose chromaticity coordinates are transformed by means of a casting compound encapsulating the semiconductor body and phosphor blend. The wavelength transforming properties of the casting compound filters the blue-yellow light generated by the combination of the blue LED and the yellow phosphor, passing most of the small portion of red wavelength component and attenuating the more dominant blue-yellow component, resulting in a consistent white output having a range of correlated color temperatures, chromaticity coordinates, and color rendering indices similar to that of an incandescent lamp output.

Accordingly, it is a principal object of the invention to produce an LED device having a CCT approximately equal to that of an incandescent light source.

It is another object of the invention to provide a method of shifting the output color of white LEDs from a high CCT of approximately 6,000 Kelvin down to approximately 3,000 Kelvin while retaining warm X-Y chromaticity indices.

It is a further object of the invention to have an output emission in all LED viewing quadrants and angles that is the same color and intensity, the consistency being due to the constant thickness of the material around the LED semiconductor material.

It is a further object of the invention to create a casting compound that passes only the desired wavelengths of light, regardless of the original semiconductor-phosphor spectrum.

It is another object of the invention to eliminate the need for extensive sorting processes to separate different color ranks of white LEDs by producing an LED of consistent color rank.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is diagrammatic view of a white light LED according to the present invention.

FIG. 2 shows the chromaticity coordinates for a light source as defined in the CIE 1931 Standard.

Similar reference characters denote corresponding features consistently throughout the attached drawings.

### DETAILED DESCRIPTION OF THE PREFERRED EMBODIMENT

The present invention is a white light LED incorporating a chromaticity coordinate-shifting casting compound encapsulating a traditional blue-yellow radiating semiconductor body and phosphor blend. The resultant white light radiating from the casting compound has a lower CCT and higher CRI than white light devices without the wavelength shifting casting compound.

Described generally as 100 in the drawings, the device builds upon previous white light LEDs, such as the LED described in U.S. patent application No. 2002/0158585, published October 2002, and hereby incorporated by reference in its entirety.

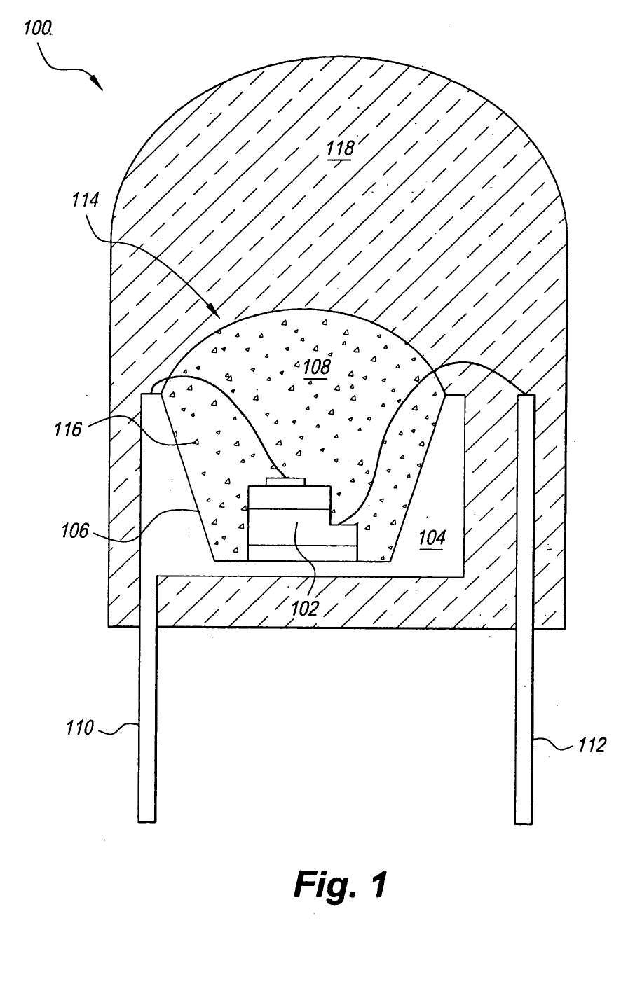

As shown in FIG. 1, the white LED 100 has a semiconductor body 102 formed of a semiconductor layer sequence capable of emitting electromagnetic radiation in a blue spectral range, the semiconductor body 102 mounted in a cup 104 having a reflective surface 106. Electrode leads 110 and 112 are provided to supply electric power to the semiconductor body 102. A transparent casing 114 comprising an epoxy or silicone 108, in which particles of an inorganic luminous substance 116 are dispersed substantially uniformly, encompasses the semiconductor body 102 and fills the cup 104. In the present invention, the luminous substance 116 is a yellow phosphor material, the phosphor being adapted to absorb the wavelength produced by the semiconductor body 102. Although the phosphor in the present embodiment radiates light having a wavelength in the yellow spectrum, the phosphor is not limited to this spectrum. Alternate combinations of light radiating semiconductors and phosphors may yield “white” light, which may. be shifted by the casting compound 118 of the present invention.

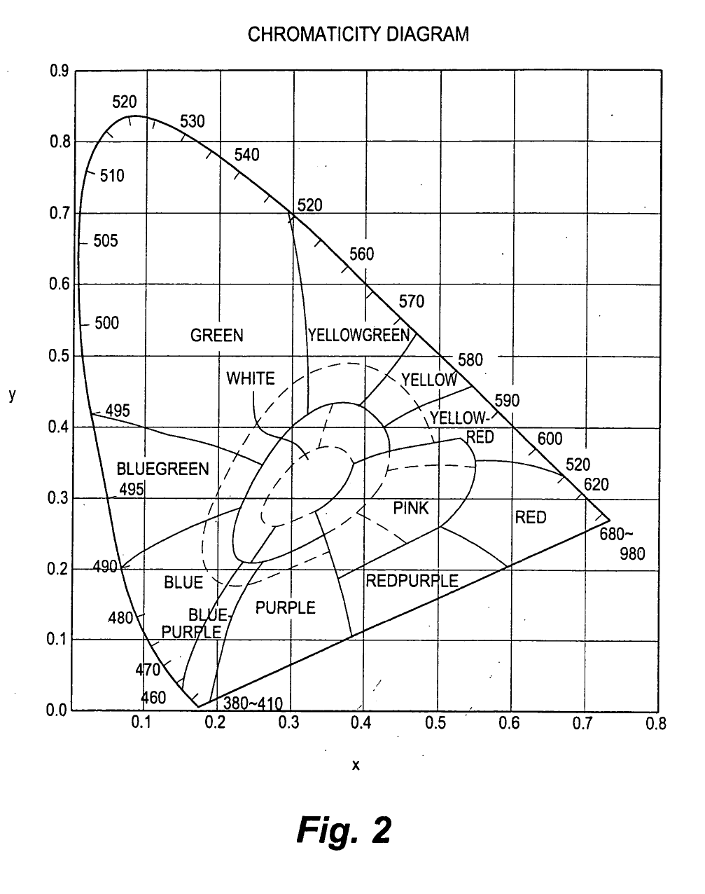

The blue light generated by the semiconductor body 102 combines with the yellow light radiated from the yellow phosphor casing 114 to create an intermediate light output with peak output wavelengths in the blue-yellow spectrum, together with substantially lower intensity wavelengths having red components. Preferably the chromaticity coordinates of the intermediate light output should fall within the “White” coordinate space shown in FIG. 2, having a CCT of approximately 5,000 to 10,000 degrees Kelvin.

The semiconductor body 102 and phosphor casing 114 is encapsulated within a casting compound 118 of the desired shape for the specific application and optical characteristics. By introducing into the casting compound 118 an optically clear tint of the proper color and ratio adapted to the doped phosphor, the resultant light output of the LED device 100 can be uniformly and consistently shifted to a limited range of desired chromaticity coordinates. When the semiconductor body 102 and phosphate casing 114 are electrically excited, the wavelength transforming properties of the casting compound 118 attenuate the dominant blue-yellow wavelength components of the intermediate light output, and passes nearly all of the small red wavelength components emitted by the semiconductor body 102. The resultant output is a consistent white output having a range of correlated color temperatures, chromaticity coordinates, and color rendering indices similar to that of an incandescent lamp output.

The casting compound 118 is formed from a polycarbonate compatible tint having a formula range of L*65.77−a*41.27−b*62.57 plus or minus 5, diluted by an epoxy resin base. (The formula uses the CIE 1976 L*a*b* color scale, a three-dimensional color space in which L* represents lightness on a scale from 0 (black) to 100 (white), a* represents redness-greenness, and b* represents yellowness-blueness.) This results in chromaticity coordinates of X-464, Y-350 with a color temperature of 1900 K. A dilution ration of 50:1, tint to epoxy, nominally provides the proper density. While these numbers indicate the preferred mix of elements which best operate with the white light LEDs commonly produced by today's manufacturers, the present invention is not limited to these formulas and ratios for obtaining these or other shift ranges.

The casting compound 118 enables a shift in output color to chromaticity coordinates X—0.466, Y—0.442 with a color temperature of 2,850 K, which corresponds almost exactly to a standard incandescent lamp output. Furthermore, the casting compound 118 allows output shifts from as low as 2,300 up to 3,300 Kelvin while retaining warm X-Y chromaticity indices. In addition, due to the broader wavelength range, a CRI of 85 is attainable, whereas the currently best CRI of alternate devices is 60. In addition, the white LED 100 maintains a consistent output in all LED viewing quadrants and angles due to the constant thickness of the casting compound 118 about the semiconductor body 102 and phosphor casing 114.

It is to be understood that the present invention is not limited to the embodiment described above, but encompasses any and all embodiments within the scope of the following claims.

1. A white light LED, comprising:
a semiconductor body formed of a semiconductor layer sequence emitting electromagnetic radiation in a blue spectral range when a forward bias is applied thereto;
a luminous material encompassing said semiconductor body, the luminous material being photoexcited by the electromagnetic radiation emission of the semiconductor body; and
a chromaticity coordinate-converting casting compound encompassing at least part of the semiconductor body and the luminous material;
wherein the LED device has a resultant white light output.

2. The white light LED according to claim 1, wherein said casting compound comprises a transparent epoxy resin having a tint of predetermined color disposed in said resin.

3. The white light LED according to claim 2, wherein said tint is a polycarbonate compatible tint, wherein said tint converts a wavelength falling within a blue wavelength range into a relatively longer wavelength.

4. The white light LED according to claim 1, wherein said semiconductor body is a blue light emitting semiconductor body.

5. The white light LED according to claim 1, wherein said luminous material is a phosphor exhibiting a yellow luminescence when photoexcited by the electromagnetic radiation emission of said semiconductor body.

6. The white light LED according to claim 1, wherein said luminous material is a Ce-doped phosphor.

7. The white light LED according to claim 1, wherein said blue light emitting semiconductor body and said luminous material emits an output wavelength in the blue-yellow spectrum.

8. The white light LED according to claim 1, wherein said white light output has an approximate correlated color temperature (CCT) between 2,300 and 3,300 Kelvin.

9. The white light LED according to claim 1, wherein said white light output has approximate chromaticity coordinates of X—0.466 and Y—0.442.

10. The white light LED according to claim 1, wherein said white light output has a nominal color rendering index (CRI) of 85.

11. A chromaticity coordinate-converting casting composition for die-level and mixed die white LEDs, the casting composition comprising:
a transparent epoxy resin; and
a polycarbonate compatible tint dispersed in said transparent epoxy resin, wherein the tint converts a wavelength falling within a blue wavelength range into a longer wavelength.

12. The casting composition according to claim 11, wherein said tint is inert to said transparent epoxy resin and die chemicals.

13. The casting composition according to claim 11, wherein said tint is chemically stabilized against ultraviolet light.

14. The casting-composition according to claim 11, wherein said tint is heat-resistant.

15. The casting composition according to claim 11, wherein said casting composition has chromaticity coordinates approximately equal to X—0.464, Y—0.350 and a color temperature of about 1900 Kelvin.

16. The casting composition according to claim 11, wherein said tint and said epoxy resin have a dilution ration of approximately 50:1.

17. The casting composition according to claim 11, wherein said tint has a formula range of L*65.77−a*41.27−b*62.57±5.

18. The casting composition according to claim 11, wherein said tint shifts the output correlated color temperature from about 6,000 Kelvin to about 3,000 Kelvin.

19. A method of adjusting the chromaticity coordinates and color rendering indices of a white LED, the method comprising the step of encapsulating said LED with a chromaticity coordinate altering compound.

20. The method according to claim 19, further including the step of forming said chromaticity coordinate altering compound by diluting polycarbonate compatible tint, having a CIE-Lab formula range of L*65.77−a*41.27−b*62.57 plus or minus 5, with clear epoxy resin with a dilution ratio of 50:1.
